(19) United States
(12) Patent Application Publication
(10) Pub. No.: US 2020/0394992 A1
(43) Pub. Date: Dec. 17, 2020

(54) CLIENT, SYSTEM AND METHOD FOR CUSTOMIZING VOICE BROADCAST

(71) Applicant: BAIDU.COM TIMES TECHNOLOGY (BEIJING) CO., LTD., Beijing (CN)

(72) Inventor: Jiamei KANG, Beijing (CN)

(21) Appl. No.: 16/897,882

(22) Filed: Jun. 10, 2020

(30) Foreign Application Priority Data
Jun. 13, 2019 (CN) 201910512750.X

(51) Int. Cl. G10L 13/033; G10L 19/00; G10L 17/00

(52) U.S. Cl. CPC G10L 13/033; G10L 17/005; G10L 19/0018

(57) ABSTRACT

Embodiments of the present disclosure provide a client for customizing voice broadcast. The client an acquisition module, an extraction module, a sample generation module and a voice playing module. The acquisition module is configured to acquire an original audio. The extraction module is configured to extract a voiceprint feature from the original audio. The sample generation module is configured to produce a sample sound effect based on the voiceprint feature extracted. The voice playing module is configured to play information to be played based on the sample sound effect.

### CROSS REFERENCE TO RELATED APPLICATIONS

This application claims priority and benefits to Chinese Application No. 201910512750.X, filed on Jun. 13, 2019, the entire content of which is incorporated herein by reference.

### FIELD

The present disclosure relates to voice broadcast, and more particularly, to a client, a system and a method for customizing voice broadcast.

### BACKGROUND

Voice broadcast, a basic function of products such as smart assistants and smart speakers based on voice functions, is to broadcast news (such as Baidu Hi) and today's events, which is one of the most commonly-used “skills” used by users when using smart voice products. In an actual scenario of the voice broadcast presently, both smart assistants and smart speakers adopt a design that the voice broadcast is performed with a unified “assistant voice”. In some scenarios, the unified voice may obstruct users' judgment on information (such as the news broadcasted) and has less fun.

### SUMMARY

Embodiments of the present disclosure provide a client for customizing voice broadcast. The client includes a processor and a memory configured to stored instructions executable by the processor. The processor is configured to:

acquire an original audio;

extract a voiceprint feature from the original audio;

produce a sample sound effect based on the voiceprint feature extracted; and

play text information to be broadcast based on the sample sound effect.

Embodiments of the present disclosure provide a voice broadcast method based on a client for customizing voice broadcast, including:

acquiring an original audio;

extracting a voiceprint feature from the original audio;

producing a sample sound effect based on the voiceprint feature extracted; and

playing text information to be broadcast based on the sample sound effect.

Embodiments of the present disclosure further provide a voice broadcast method based on a server for customizing voice broadcast, including:

receiving, sent by the client, a voiceprint feature corresponding to a sample sound effect selected by the user;

generating a sound effect model by training the voiceprint feature corresponding to the sample sound effect received; and

sending the sound effect model generated by training the voiceprint feature corresponding to the sample sound effect to the client.

Other features and advantages of the embodiments of the present disclosure will be described in detail in the following detailed implementations.

### BRIEF DESCRIPTION OF THE DRAWINGS

The accompanying drawings are used to provide a further understanding of the embodiments of the present disclosure, and constitute a part of the description. Together with the following specific implementations, the accompany drawings are used to explain the embodiments of the present disclosure, rather than to limit the embodiments of the present disclosure.

FIG. 1 is a block diagram illustrating a client for customizing voice broadcast according to embodiments of the present disclosure.

FIG. 2 is a block diagram illustrating a client for customizing voice broadcast according to embodiments of the present disclosure.

FIG. 3 is a block diagram illustrating a server for customizing voice broadcast according to embodiments of the present disclosure.

FIG. 4 is a block diagram illustrating a system for customizing voice broadcast according to embodiments of the present disclosure.

FIG. 5 is a flowchart illustrating a voice broadcast method based on a client for customizing voice broadcast according to embodiments of the present disclosure.

FIG. 6 is a flowchart illustrating a voice broadcast method based on a system for customizing voice broadcast according to embodiments of the present disclosure.

### DETAILED DESCRIPTION

The specific implementations of the embodiments of the present disclosure will be described in detail below with reference to the accompanying drawings. It should be understood that the specific implementations described herein are only used to illustrate and explain the embodiments of the present disclosure, and are not intended to limit the embodiments of the present disclosure.

Inventors of the present disclosure has found that existing solutions may have the following defects.

1. The unified voice is adopted, so that when new conversation messages are broadcasted, especially when new messages from a chat group are broadcasted, a user needs to pay high attention to names and messages of speakers to determine the logic relationship between the message source and the context, which requires energy. For example, a case is that a female voice is adopted to broadcast a message from a male.

2. The unified voice is less funny and less emotional.

3. When the user does not like the voice provided by a platform, there is no other choice.

4. The smart terminal cannot provide a sound effect sample. The sound effect may be obtained by the user after a synthesized voice packet is transmitted from a server to a client.

Therefore, the present disclosure provides a client, a server, a system and a method for customizing voice broadcast. The client for customizing voice broadcast may produce a sample sound effect in advance based on acquired voiceprint features. After listening to the sample sound effect, a user may determine whether to produce a sound effect model of the sound effect, thereby simplifying a process of obtaining the sound effect by the user, saving waiting time of the user and reducing work intensity of a server.

Based on the above technical solutions, the client for customizing voice broadcast may acquire the original audio via the acquisition module, extract the voiceprint feature from the original audio via the extraction module, produce the sample sound effect based on the voiceprint feature extracted via the sample generation module, and play the sample sound effect via the voice playing module. After listening to the sample sound effect, a user may determine whether to produce a sound effect model of the sound effect, thereby simplifying a process of obtaining the sound effect by the user, saving waiting time of the user and reducing work intensity of a server.

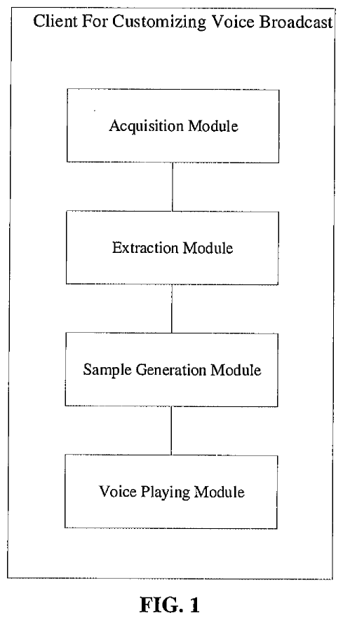

FIG. 1 is a block diagram illustrating a client for customizing voice broadcast according to embodiments of the present disclosure. As illustrated in FIG. 1, the client may include: an acquisition module, an extraction module, a sample generation module and a voice playing module. The acquisition module may be configured to acquire an original audio expected by a user. For example, the user may record a piece of original audio about himself/herself, or his/her family or friends. The extraction module may be configured to extract voiceprint features of the original audio acquired by the acquisition module. The sample generation module may be configured to generate a sample sound effect based on the voiceprint features extracted by the extraction module. The voice playing module may be configured to play text information that needs to be broadcast based on the sample sound effect, so that the user may obtain the sample sound effect. After getting the sample sound effect, the user may decide whether to further produce a sound effect model of the sample sound effect. For example, the original audios of friend A, friend B and friend C may be obtained. The voiceprint features of each original audio may be extracted. Based on the voiceprint features extracted, a sample sound effect of the friend A, a sample sound effect of the friend B and a sample sound effect of the friend C are generated respectively. After the sample sound effects are listened by the user, the user may decide to use the sound effect of the friend C. Therefore, it is possible to quickly decide the sound effect required by the user simply by the client when the client is not connected with the network.

Regarding extracting the voiceprint features, the extraction module may be configured to automatically extract the voiceprint features in an audio file saved after a voice function of the client is activated by the user. For example, the extraction module may be configured to extract the voiceprint features of the user or another person in the audio file saved after the user chats with another person in voice through an application of Baidu Hi. In a case where the voiceprint features cannot be extracted from the audio file saved in the client or there is no audio file corresponding to the expected sound effect in the client, the audio file corresponding to the user expected sound effect may be recorded and the voiceprint features may be extracted from the recorded audio file. User authorization may be obtained before the voiceprint features of the audio file saved in the client are automatically extracted by the extraction module. In a case where a function of automatically extracting the voiceprint features is activated by the user, it may be considered that a user authorization instruction is obtained, such that the extraction module may automatically extract the voiceprint features of the audio file saved in the client. In order to protect privacy information of an owner of the extracted voiceprint features, the extraction module may be configured to adjust one or more of the extracted voiceprint features in a preset manner such that the sound effect produced based on the adjusted voiceprint features is similar to the sound effect of the speaker.

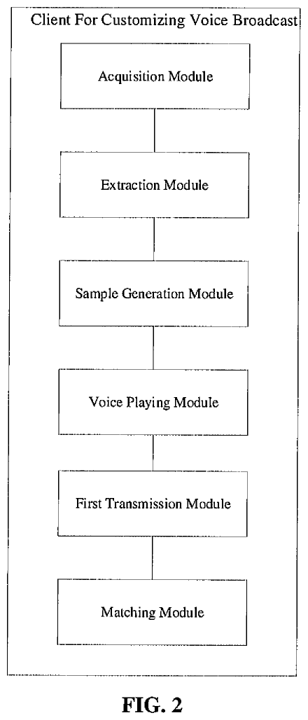

FIG. 2 is a block diagram illustrating a client for customizing voice broadcast according to embodiments of the present disclosure. As illustrated in FIG. 2, the client may further include a first transmission module. After the user listens to the sample sound effects and selects his/her desired sound effect, the first transmission module may be configured to send the voiceprint feature corresponding to the sample sound effect selected to the server. FIG. 3 is a block diagram illustrating a server for customizing voice broadcast according to embodiments of the present disclosure. As illustrated in FIG. 3, the server may include a second transmission module and a training module. The second transmission module may be configured to receive the voiceprint feature corresponding to the sample sound effect selected that is sent by the first transmission module of the client. The training module may be configured to generate the sound effect model by training the voiceprint feature corresponding to the sample sound effect received by the second transmission module. In addition, the second transmission module may be further configured to send the sound effect model provided by the training module to the client. The client may store the sound effect model received locally for subsequent use.

As illustrated in FIG. 2, the client may further include a matching module. The matching module may be configured to bind a locally stored sound effect model to a contact in an address book. For example, the address book of the client may include the friend A, the friend B and the friend C. Respective sound effect models of the friend A, the friend B and the friend C are generated. The locally-stored sound effect models of the friend A, the friend B and the friend C are bound to the friend A, the friend B and the friend C of the address book respectively, for subsequent use. When the user is chatting with the friend A of the address book, in a case where the user is unable to view the screen in real time to get the text information sent by the friend A (for example, the user is driving), a voice broadcast function may be activated by the user for the chatting event. The first transmission module may be configured to send the sound effect model bound to the friend A of the address book and the text information sent by the friend A to the server. As illustrated in FIG. 3, the server may further include a synthesis module. In detail, the synthesis module may be configured to synthesize the sound effect model of the friend A and the text information sent by the friend A into a customized voice of the friend A. The second transmission module of the server may be configured to send the customized voice of the friend A to the client. The voice broadcast module of the client may be configured to automatically broadcast the received customized voice of the friend A. Consequently, in the case where the user cannot view the screen in real time to get the text information sent by the friend A, the user may, by means of the voice broadcast function, listen to the content of the text information sent by the friend A that is broadcasted in the sound effect of the friend A.

As illustrated in FIG. 2, the client may further include a configuration module. The configuration module may be configured to configure a voice broadcast event of the client based on the sound effect models stored locally on the client. For example, applications (Apps) of the client for implementing the voice broadcast function may include: event reminder, news App, toddler story App, road navigation and the like. Based on the sound effect models stored locally on the client, the sound effect of the user may be configured as the broadcast sound effect for the event reminder, the sound effect of Bai Yansong as the broadcast sound effect for the news broadcast, the sound effect of a kid's mother as the broadcast sound effect for the toddler story, and the sound effect of a husband as the broadcast sound effect for the road navigation. In using the above-mentioned Apps for implementing the voice broadcast function, the first transmission module may be configured to send, to the server, the sound effect model corresponding to the sound effect configured for each application and the text information to be broadcast. The synthesis module of the server may be configured to synthesize the sound effect model corresponding to the sound effect configured for each application and the text information to be broadcast and provide the corresponding customized voice. The corresponding customized voice may be sent to the client through the second transmission module. The corresponding customized voice may be broadcasted in the corresponding sound effect through the voice broadcast module.

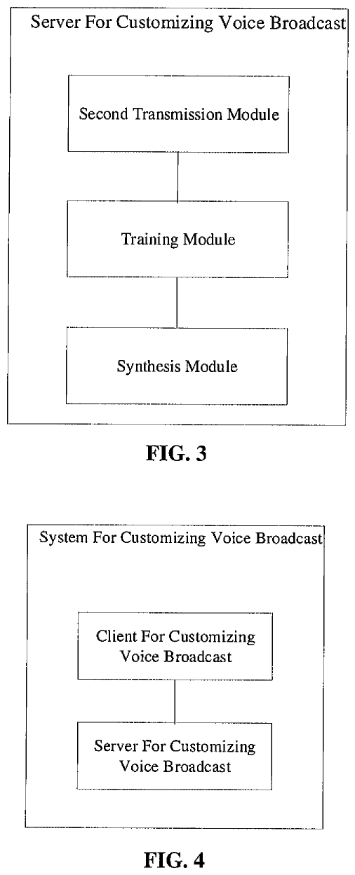

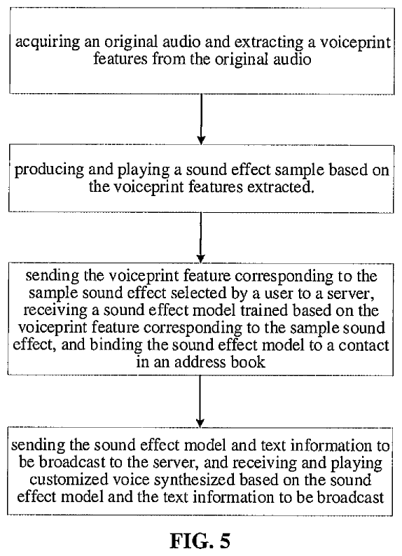

FIG. 4 is a block diagram illustrating a system for customizing voice broadcast system according to embodiments of the present disclosure. As illustrated in FIG. 4, the system may include the client for customizing voice broadcast and the server for customizing voice broadcast. The client and the server may be connected with each other through network. The client may generate and provide a sample sound effect to the user for reference based on the acquired voiceprint features in a case where the client is not connected to the network. In addition, the client may send the voiceprint features corresponding to the sample sound effect selected by the user to the server in a case where the client is connected to the network, such that the server may train the voiceprint features and provide a corresponding sound effect model. When an App of the client is activated for implementing the voice broadcast function, the configured sound effect model and the text information to be broadcast may be sent to the server. The server may synthesize the sound effect model and the text information to be broadcast and provide the corresponding customized voice file. The customized voice file may be sent to the client for voice broadcast.

In an example, based on user requirements, the client may be configured to directly send the extracted voiceprint features to the server without producing the sample sound effect, such that the server may provide the corresponding sound effect model.

### Device Embodiment

The original audios of the friend A, the friend B and the friend C may be acquired through the acquisition module. The voiceprint feature of each original audio may be extracted through the extraction module. The extracted voiceprint features may be adjusted in a preset manner. Based on the extracted voiceprint features, the sample sound effect of the friend A, the sample sound effect of the friend B, and the sample sound effect of the friend C may be generated by the sample synthesis module. The sample sound effects may be played through the voice broadcast module. The voiceprint feature corresponding to the sound effect model of the friend C selected by the user may be sent to the server through the first transmission module. The training module in the server may be configured to train the voiceprint feature corresponding to the sound effect model of the friend C selected by the user and produce the corresponding sound effect model. The second transmission module of the server may be configured to send the sound effect model of the friend C to the client. The sound effect of the friend C may be configured as the broadcast sound effect for a reminding event through the configuration module of the client. The first transmission module of the client may be configured to send the text content of the reminding event and the sound effect model of the friend C to the server. The synthesis module of the server may be configured to synthesize the text content of the reminding event and the sound effect model of the friend C to provide a customized voice of the reminding event in the sound effect of the friend C. The second transmission module is configured to send the customized voice of the reminding event in the sound effect of the friend C to the client. Based on reminding time set by the event reminder, the voice broadcast module may be configured to automatically broadcast the content of the reminding event in the sound effect of the friend C at the reminding time.

In the case where an automatic voiceprint extraction mode is activated, the voiceprint features in the audio file saved after the user chats with his wife in voice may be automatically extracted by the extraction module. The extracted voiceprint features of the user and his wife may be adjusted in the preset manner. The voiceprint features adjusted in the preset manner of the user and his wife may be sent to the server through the first transmission module. The original audios of the friend A, the friend B and the friend C may be recorded through the acquisition module. The voiceprint feature of each original audio may be extracted through the extraction module. The extracted voiceprint features may be adjusted in the preset manner. The voiceprint features adjusted in the preset manner of the friend A, the friend B and the friend C may be sent to the server through the first transmission module. The second transmission module of the server may be wirelessly connected to the first transmission module of the client to receive the voiceprint features adjusted in the preset manner of the user and his wife and the voiceprint features adjusted in the preset manner of the friend A, the friend B and the friend C sent by the first transmission module. The training module of the server may be configured to train the voiceprint features received by the second transmission module and generate the corresponding sound effect model. The second transmission module may be configured to send the sound effect model trained and generated by the training module to the client. The client may be configured to store the received sound effect model locally and bind the sound effect model stored locally to a corresponding contact in the address book of Baidu Hi on the client. In detail, the wife, the friend A, the friend B and the friend C in the address book may be respectively bound with respective sound effect models. When a piece of text information is sent by the friend A through the application of Baidu Hi and the user is on driving, the user is unable to check the screen of the phone in real time to get the text information sent by the friend A. After the voice broadcast function of the application of Baidu Hi is activated by the user, the first transmission module of the client may be configured to send the sound effect model of the friend A and the text information sent by the friend A to the server. The synthesis module of the server may be configured to synthesize the sound effect module of the friend A and the text information sent by the friend A to provide a customized voice file for broadcasting the text information sent by the friend A in the sound effect of the friend A. The customized voice file may be sent to the client. The voice broadcast module of the client may be configured to automatically broadcast the customized voice received by the client. That is, the user may listen to the text information sent by the friend A that is broadcasted in the sound effect of the friend A during driving.

FIG. 5 is a flowchart illustrating a voice broadcast method based on a client for customizing voice broadcast according to embodiments of the present disclosure. As illustrated in FIG. 5, the method may include the following. An original audio expected by the user is acquired. For example, the user may record a piece of original audio about himself/herself, or his/her family or friends. A voiceprint feature of the original audio acquired is extracted. A sample sound effect is produced based on the extracted voiceprint feature. Text information to be broadcast is played based on the sample sound effect, such that the user gets the sound effect of the sample sound effect. After listening to the sample sound effect, the user may decide whether to produce a sound effect model of the sound effect. For example, after the original audios of a friend A, a friend B and a friend C are acquired and the voiceprint feature of each original audio is extracted, the sample sound effect of the friend A, the sample sound effect of the friend B and the sample sound effect of the friend C may be produced respectively based on the extracted voiceprint features. After listening to the sample sound effects, the user may decide to use the sound effect of the friend C. Therefore, it may be possible to quickly decide the sound effect required by the user simply through the client when the client is not connected to the network.

Regarding extracting the voiceprint feature, the voiceprint features in an audio file saved after a voice function of the client is activated by the user may be automatically extracted. For example, the voiceprint features of the user or another person in the audio file saved after the user chats with another person in voice through an application of Baidu Hi may be extracted. In a case where the voiceprint features cannot be extracted from the audio file saved in the client or there is no audio file corresponding to the expected sound effect in the client, the audio file corresponding to the user expected sound effect may be recorded. The voiceprint features may be extracted from the recorded audio file. User authorization may be obtained before the voiceprint features of the audio file saved in the client are automatically extracted. In a case where a function of automatically extracting the voiceprints is activated by the user, it may be considered that a user authorization instruction is obtained, such that the voiceprint features of the audio file saved in the client may be automatically extracted. In order to protect privacy information of an owner of the extracted voiceprint features, one or more of the extracted voiceprint features may be adjusted in a preset manner such that the sound effect produced based on the adjusted voiceprint features is similar to the sound effect of the speaker.

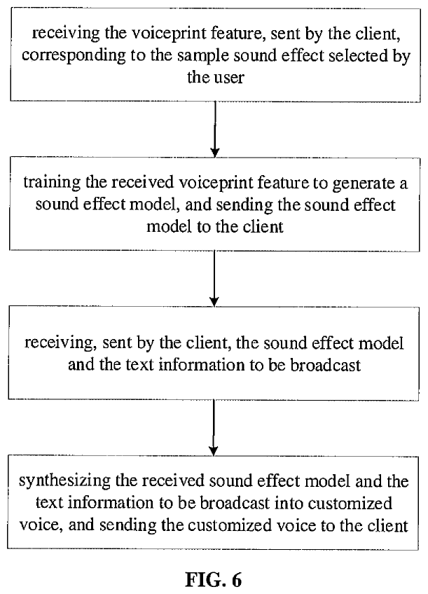

After the user selects his/her desired sample sound effect by listening to the sample sound effects, the voiceprint features corresponding to the selected sample sound effect may be sent to the server. FIG. 6 is a flowchart illustrating a voice broadcast method based on a server for customizing voice broadcast according to embodiments of the present disclosure. The method may include: receiving the voiceprint feature corresponding to the selected sample sound effect sent by the client, generating the sound effect model by training the received voiceprint feature corresponding to the sample sound effect, and sending the sound effect model to the client. The client may be configured to store the received sound effect model locally for subsequent use.

As illustrated in FIG. 5 and FIG. 6, the method may further include binding a locally stored sound effect model to a contact of the address book. For example, the address book of the client may include a friend A, a friend B and a friend C. The sound effect models of the friend A, the friend B and the friend C are generated respectively. The locally-stored sound effect models of the friend A, the friend B and the friend C may be bound to the friend A, the friend B and the friend C of the address book respectively, for subsequent use. When the user is chatting with the friend A of the address book, in the case where the user cannot view the screen in real time to get the text information sent by the friend A (for example the user is driving), the user may activate the voice broadcast function for the chatting event. In this case, the sound effect model bound to the friend A of the address book and the text information sent by the friend A may be sent to the server. The sound effect model of the friend A and the text information sent by the friend A may be synthesized into a customized voice of the friend A through the server. The customized voice of the friend A may be sent to the client, such that the received customized voice of the friend A may be automatically broadcast. Consequently, in the case where the user cannot view the screen in real time to get the text information sent by the friend A, the user may, by means of the voice broadcast function, listen to content of the text information sent by the friend A that is broadcasted in the voice effect of the friend A.

As illustrated in FIG. 5 and FIG. 6, the voice broadcast event in the client may be configured based on sound effect models stored locally at the client. For example, applications (Apps) of the client for implementing the voice broadcast function may include: event reminder, news App, toddler story App, road navigation and the like. Based on the sound effect models stored locally at the client, the sound effect of the user may be configured as the broadcast sound effect for the event reminder, the sound effect of Bai Yansong as the broadcast sound effect for the news broadcast, the sound effect of a kid's mother as the broadcast sound effect for the toddler story App, and the sound effect of a husband as the broadcast sound effect for the road navigation. In using the above-mentioned Apps for implementing the voice broadcast function, the sound effect model corresponding to the sound effect configured for each application and the text information to be broadcast may be sent to the server. The server may be configured to synthesize the sound effect model corresponding to the sound effect configured for each application and the text information to be broadcast to provide the corresponding customized voice. The corresponding custom voice may be sent to the client. Therefore, the text information may be broadcast in the corresponding sound effect.

With the voice broadcast method based on the system for customizing voice broadcast, the client and the server are connected with each other through the network. The client may generate and provide the sample sound effect to the user for reference based on the acquired voiceprint features in a case where the client is not connected to the network. In addition, the client may send the voiceprint features corresponding to the sample sound effect selected by the user to the server in a case where the client connected to the network, such that the server may train the voiceprint features and provide the corresponding sound effect model. When an App of the client is activated for implementing the voice broadcast function, the configured sound effect model and the text information to be broadcast may be sent to the server. The server may synthesize the sound effect model and the text information to be broadcast and provide the corresponding customized voice file. The customized voice file may be sent to the client for voice broadcast.

### Method Embodiment

The original audios of the friend A, the friend B and the friend C may be acquired. The voiceprint feature of each original audio may be extracted. The extracted voiceprint feature may be adjusted in a preset manner. Based on the extracted voiceprint features, the sample sound effect of the friend A, the sample sound effect of the friend B, and the sample sound effect of the friend C are produced respectively and played. The voiceprint feature corresponding to the sound effect model of the friend C selected by the user may be sent to the server. The server may train the voiceprint feature corresponding to the sound effect model of the friend C selected by the user and produce the corresponding sound effect model. The server may send the sound effect model of the friend C to the client, and the sound effect of the friend C may be configured as the broadcast sound effect of the event reminder by the client. The client may also send the text content of the event to be reminded and the sound effect model of the friend C to the server, such that the server may synthesize the text content of the event to be reminded and the sound effect model of the friend C to provide a customized voice of the event to be reminded in the sound effect of of friend C. The customized voice of the event to be reminded in the sound effect of the friend C may be sent to the client. Based on the reminding time set for the event to be reminded, the content of the event to be reminded may be automatically broadcast in the sound effect of the friend C at the set reminding time.

In a case of controlling to activate the automatic voiceprint extraction mode, the voiceprint features of the user and his wife may be automatically extracted from the audio file saved after the user chats with his wife. The voiceprint features of the user and his wife may be adjusted in a preset manner. The voiceprint features of the user and his wife that are adjusted in the preset mode may be sent to the server. The original audios of the friend A, the friend B and the friend C may be recorded. The voiceprint feature of each original audio may be extracted. The extracted voiceprint features may be adjusted in the preset manner and sent to the server. The server is wirelessly connected to the client to receive, sent by the client, the voiceprint features of the user and his wife adjusted in the preset manner and the voiceprint features of the friend A, the friend B and the friend C adjusted in the preset manner. The corresponding sound effect model may be generated by training the voiceprint feature received. The sound effect model generated may be sent to the client. The received sound effect model may be stored locally and bound to the corresponding contact in the address book of Baidu Hi on the client. In detail, the wife, the friend A, the friend B and the friend C in the address book may be respectively bound to respective sound effect models. In a case where a piece of text information is sent by the friend A through the application of Baidu Hi and the user is driving a vehicle, the user is unable to view the phone screen in real time to get the information sent by the friend A. After the voice broadcast function of the application of Baidu Hi is activated, the client may send the sound effect model of the friend A and the text information sent by the friend A to the server. The server may synthesize the sound effect module of the friend A and the text information sent by the friend A to provide a customized voice file of broadcasting the text information sent by the friend A in the sound effect of the friend A. The customized voice file may be sent to the client. The client may automatically broadcast the customized voice received by the client. That is, the user may listen to the text information sent by the friend A that is broadcast in the sound effect of the friend A, during driving.

The client and server device may each include a processor and a memory. The above-mentioned acquisition module, extraction module, sample generation module, voice playing module, first transmission module, matching module, configuration module, second transmission module, training module and synthesis module may be all stored in the memory as program modules. The processor may be configured to execute the above program modules stored in the memory to implement corresponding functions.

The processor may include a kernel. The kernel may be configured to call a program unit from the memory. One or more kernels may be set. By adjusting kernel parameters, the tediousness for the user to obtain the sound effect may be reduced, thereby saving waiting time for the user, reducing the work intensity of the server and providing diversified options for sound effects.

The memory may include a non-persistent memory, a random access memory (RAM), and/or a non-volatile memory in computer readable media, such as a read-only memory (ROM) or a flash memory (flash RAM). The memory includes at least one memory chip.

Embodiments of the present disclosure may provide a storage medium having a program stored thereon. When the program is executed by a processor, the processor may be configured to perform the voice broadcast method based on a client for customizing voice broadcast and the voice broadcast method based on a server for customizing voice broadcast.

Embodiment of the present disclosure may provide a processor for running a program. When the program is run, the program executes the voice broadcast method based on the custom voice broadcast client and the voice broadcast method based on the custom voice broadcast server.

Embodiments of the present disclosure provide a device. The device may include a processor, a memory, and programs stored on the memory and executable by the processor. When the programs are executed by the processor, the processor is configured to acquire an original audio; extract a voiceprint feature from the original audio; produce the sample sound effect based on the voiceprint feature extracted; and play the text information to be broadcast based on the sample sound effect.

In an example, acquiring the original audio and extracting the voiceprint feature from the original audio may include automatically extracting the voiceprint feature from an audio file saved after the user activated the voice function; and/or recording an audio file of another person, and extracting the voiceprint feature from the audio file of another person.

In an example, the method may further include: sending the voiceprint feature corresponding to the sample sound effect selected by the user to the server; and receiving the sound effect model sent by the server and trained based on the voiceprint feature corresponding to the sample sound effect selected by the user.

In an example, the method may further include: directly sending the voiceprint feature extracted from the original audio to the server; and receiving the sound effect model sent by the server and trained based on the voiceprint feature extracted from the original audio.

In an example, the method may further include: sending the sound effect model selected by the user and the text information to be broadcast to the server; receiving the customized voice synthesized by the server based on the sound effect model selected by the user and the text information to be broadcast; and playing the customized voice synthesized based on the sound effect model selected by the user and the text information to be broadcast.

In an example, the method may further include: binding the sound effect model to a contact in the address book.

In a case where the user communicates with the contact in the address book, the following operations may be executed. The sound effect model bound to the contact in the address book and the text information sent by the contact in the address book are sent to the server. The customized voice synthesized and sent by the server based on the sound effect model bound to the contact in the address book and the text information sent by the contact in the address book is received. The customized voice synthesized based on the sound effect model bound to the contact in the address book and the text information sent by the contact in the address book is played.

In an example, the method may further include: receiving, sent by the client, the voiceprint feature corresponding to the sample sound effect selected by the user; generating the sound effect model by training the voiceprint feature corresponding to the sample sound effect received; and sending the sound effect model generated by training the voiceprint feature corresponding to the sample sound effect to the client.

In an example, the method may further include: receiving, sent by the client, the voiceprint feature extracted from the original audio sent by the client; generating the sound effect model by training the voiceprint feature extracted from the original audio; and sending the sound effect model generated by training the voiceprint feature extracted from the original audio to the client.

In an example, the method may further include: receiving, sent by the client, the sound effect model selected by the user and the text information to be broadcast; synthesizing the sound effect model selected by the user and the text information to be broadcast to generate a customized voice; and sending the customized voice synthesized to the client. The device in the present disclosure may be a server, a PC, a PAD, a mobile phone and so on.

The present disclosure further provides a computer program product. When the computer program product is executed on a data processing device, a program initialized with the following blocks may be executed. An original audio is obtained to extract a voiceprint feature from the original audio. A sample sound effect is generated based on the voiceprint feature extracted. The text information to be broadcast is played based on the sample sound effect.

In an example, acquiring the original audio and extracting the voiceprint feature from the original audio may include: automatically extracting the voiceprint feature from an audio file saved after the user activates the voice function; and/or recording an audio file of another person and extracting the voiceprint feature from the audio file of another person.

In an example, the method may further include: sending the voiceprint feature corresponding to the sample sound effect selected by the user to the server; and receiving, sent by the server, the sound effect model trained based on the voiceprint feature corresponding to the sample sound effect selected by the user.

In an example, the method may further include: directly sending the voiceprint feature extracted from the original audio to the server; and receiving, sent by the server, the sound effect model trained based on the voiceprint feature extracted from the original audio.

In an example, the method may further include: sending the sound effect model selected by the user and the text information to be broadcast to the server; receiving the customized voice synthesized by the server based on the sound effect model selected by the user and the text information to be broadcast; and playing the customized voice synthesized based on the sound effect model selected by the user and the text information to be broadcast.

In an example, the method may further include: binding the sound effect model received to a contact in the address book.

In a case where the user communicates with the contact in the address book, the following blocks may be executed. The sound effect model bound to the contact in the address book and the text information sent by the contact in the address book are sent to the server. The customized voice synthesized and sent by the server based on the sound effect model bound to the contact in the address book and the text information sent by the contact in the address book. The customized voice synthesized based on the sound effect model bound to the contact in the address book and the text information sent by the contact in the address book is played.

In an example, the method may further include: receiving, sent by the client, the voiceprint feature corresponding to the sample sound effect selected by the user; generating the sound effect model by training the voiceprint feature corresponding to the sample sound effect received; and sending the sound effect model generated by training the voiceprint feature corresponding to the sample sound effect to the client.

In an example, the method may further include: receiving, sent by the client, the voiceprint features extracted from the original audio; generating the sound effect model by training the voiceprint feature extracted from the original audio; and sending the sound effect model generated by training the voiceprint feature extracted from the original audio to the client.

In an example, the method may further include: receiving, sent by the client, the sound effect model selected by the user and the text information to be broadcast; synthesizing the sound effect model selected by the user and the text information to be broadcast to generate the customized voice; and sending the customized voice synthesized to the client.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The present disclosure is described with reference to implementation flowcharts and/or block diagrams of a method, a device (a system) and a computer program product according to embodiments of the present disclosure. It may be understood that each flow and/or block in a flowchart and/or a block diagram, and a combination of a flow and/or a block in a flowchart and/or a block diagram may be implemented by computer program instructions. The computer program instructions may be provided to a processor in a general purpose computer, a special purpose computer, an embedded processor, or other programmable data processing devices to produce a machine, so that instructions executed by a processor in a computer or other programmable data processing devices generate a means configured to implement functions specified in one or more flows in a flowchart and/or one or more blocks in a block diagram.

The computer program instructions may also be stored in a computer readable memory that may instruct a computer or other programmable data processing devices to operate in a particular manner, such that the instructions stored in the computer readable memory produce a manufactured product including an instruction device. The device implements functions specified in one or more flows in a flowchart and/or one or more blocks in a block diagram.

These computer program instructions may also be loaded onto a computer or other programmable data processing devices such that a series of operational steps are performed on a computer or other programmable devices to produce processing implemented by the computer. Consequently, instructions executed on the computer or other programmable devices provide steps for implementing the functions specified in one or more flows in a flowchart and/or one or more blocks in a block diagram.

In a typical configuration, a computing device includes one or more processors (CPUs), input/output interfaces, network interfaces and memories.

The memory may include a non-permanent memory, a random access memory (RAM), and/or a non-volatile memory in the computer readable media, such as a read-only memory (ROM) or a flash memory (flash RAM). The memory is an example of a computer readable media.

The computer readable media include a permanent, non-permanent, removable and non-removable medium, and the target information may be stored by any method or technology. The target information may be computer readable instructions, data structures, modules of a program, or other data. Examples of the storage medium of the computer include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage device, a magnetic tape cartridge, a magnetic tape, a magnetic disk storage device or other magnetic storage devices or any other non-transmission media, which can be used to store target information that may be accessed by a computing device. As defined herein, the computer readable media do not include temporary computer-readable media (transitory media) such as modulated data signals and carrier waves.

It should also be noted that the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The above are only embodiments of the present disclosure and are not intended to limit the present disclosure. For those skilled in the art, various modifications and changes may be performed on the present disclosure. Any modification, equivalent replacement and improvement made within the spirit and principle of the present disclosure shall be included in the scope of attached claims of the present disclosure.

What is claimed is:

1. A client for customizing voice broadcast, comprising:
a processor; and
a memory, configured to store instructions executable by the processor,
wherein when the instructions are executed by the processor, the processor is configured to:
acquire an original audio;
extract a voiceprint feature from the original audio;
generate a sample sound effect based on the voiceprint feature extracted; and
play text information to be broadcast based on the sample sound effect.

2. The client of claim 1, wherein the processor is further configured to:
automatically extract the voiceprint feature from an audio file saved after a voice function is activated by a user; and/or
record an audio file of another person, and extract the voiceprint feature from the audio file of another person.

3. The client of claim 1, wherein the processor is further configured to:
send the voiceprint feature corresponding to the sample sound effect selected by the user to a server; and
receive, sent by the server, a sound effect model trained based on the voiceprint feature corresponding to the sample sound effect selected by the user.

4. The client of claim 1, wherein the processor is further configured to:
directly send the voiceprint feature extracted from the original audio to a server; and
receive, sent by the server, a sound effect model trained based on the voiceprint feature extracted from the original audio.

5. The client of claim 3, wherein the processor is further configured to:
send the sound effect model selected by the user and the text information to be broadcast to the server; and
receive a customized voice synthesized by the server based on the sound effect model selected by the user and the text information to be broadcast; and
play the customized voice received.

6. The client of claim 5, wherein the processor is further configured to:
bind the sound effect model received to a contact in an address book;
wherein when the user communicates with the contact in the address book, send the sound effect model bound to the contact in the address book and the text information sent by the contact in the address book to the server; and receive, sent by the server, the customized voice synthesized based on the sound effect model bound to the contact in the address book and the text information sent by the contact in the address book; and
play the customized voice sent by the server.

7. A server for customizing voice broadcast, comprising:
a processor; and
a memory, configured to store instructions executable by the processor,
wherein when the instructions are executed by the processor, the processor is configured to:
receive, sent by a client, a voiceprint feature corresponding to a sample sound effect selected by a user;
generate a sound effect model by training the voiceprint feature corresponding to the sample sound effect received; and
send the sound effect model generated based on training the voiceprint feature corresponding to the sample sound effect to the client.

8. The server of claim 7, wherein the processor is further configured to:
receive, sent by the client, the voiceprint feature extracted from an original audio;
generate the sound effect model by training the voiceprint feature extracted from the original audio received; and
send the sound effect model generated by training the voiceprint feature extracted from the original audio to the client.

9. The server of claim 7, wherein the processor is further configured to:
receive, sent by the client, the sound effect model selected by the user and text information to be broadcast;
synthesize the sound effect model selected by the user and the text information to be broadcast to generate a customized voice; and
send the customized voice synthesized to the client.

10. A voice broadcast method based on a client for customizing voice broadcast, comprising:
acquiring an original audio;
extracting a voiceprint feature from the original audio;
producing a sample sound effect based on the voiceprint feature extracted; and
playing text information to be broadcast based on the sample sound effect.

11. The method of claim 10, wherein acquiring the original audio and extracting the voiceprint feature from the original audio comprises:
automatically extracting the voiceprint feature from an audio file saved after a voice function is activated by a user; and/or
recording an audio file of another person, and extracting the voiceprint feature from the audio file of another person.

12. The method of claim 10, further comprising:
sending the voiceprint feature corresponding to the sample sound effect selected by the user to a server; and
receiving, sent by a server, a sound effect model trained based on the voiceprint feature corresponding to the sample sound effect selected by the user.

13. The method of claim 10, further comprising:
directly sending the voiceprint feature extracted from the original audio to a server; and
receiving, sent by the server, a sound effect model trained based on the voiceprint feature extracted from the original audio.

14. The method of claim 12, further comprising:
sending the sound effect model selected by the user and the text information to be broadcast to the server;
receiving a customized voice synthesized by the server based on the sound effect model selected by the user and the text information to be broadcast; and
playing the customized voice synthesized based on the sound effect model selected by the user and the text information to be broadcast.

15. The method of claim 14, further comprising:
binding the sound effect model received to a contact in an address book;
when the user communicates with the contact in the address book,
ending the sound effect model bound to the contact in the address book and the text information sent by the contact in the address book to the server; and
receiving, sent by the server, the customized voice synthesized based on the sound effect model bound to the contact in the address book and the text information sent by the contact in the address book; and
playing the customized voice synthesized based on the sound effect model bound to the contact in the address book and the text information sent by the contact in the address book.
